(19) United States
(12) Patent Application Publication
(10) Pub. No.: US 2004/0072708 A1
(43) Pub. Date: Apr. 15, 2004

(54) Process for producting a water soluble package

(76) Inventors: Paul John Duffield, Beverley (GB); David Brian Edwards, Stevenage (GB)

Correspondence Address: Norris McLaughlin & Marcus, 30th Floor, 220 East 42nd Street, New York, NY, 10017, US

(21) Appl. No.: 10/471,184

(22) PCT Filed: Mar. 14, 2002
(86) PCT No.: PCT/GB02/01041

(30) Foreign Application Priority Data
Mar. 16, 2001 (GB) 0106548.1

(51) Int. Cl. C11D 17/00

(52) U.S. Cl. 510/293

(57) ABSTRACT

A process for producing a container containing a composition which comprises producing a pocket surrounded by a sealing portion in a film; coating the inside of the pocket but not the sealing portion with a coating; filling the pocket with the composition; placing a film on top of the filled pocket and across the sealing portion; and sealing the films together at the sealing portion.

The present invention relates to a process for producing a container from a film.

It is known to package chemical compositions, particularly those which may be of a hazardous or irritant nature, in films, particularly water soluble films. Such containers can simply be added to water in order to dissolve or disperse the contents of the container into the water.

For example, WO 89/12587 discloses a package which comprises an envelope of a water soluble material which comprises a flexible wall and a water-soluble heat seal. The package may contain an organic liquid comprising, for example, a pesticide, fungicide, insecticide or herbicide.

WO 92/17382 discloses a package containing an agrochemical comprising a first sheet of non-planar water-soluble or water-dispersible material and a second sheet of water-soluble or water-dispersible material superposed on the first sheet and sealed to it. When the package contains a liquid, the liquid must be an organic liquid which contains less than 2 to 3% of water to ensure that it does not attack the film forming the package and cause leakage.

Thus it has been necessary to ensure that the contents of the container are compatible with the film forming the container to ensure that leakage does not occur.

It is known to coat the inside surfaces of the film with a coating which protects the film from these compositions. For example, WO 00/64667 discloses the use of a multi-layer film which comprises a continuous layer of water-soluble material suitable for forming an outer layer of bag and a discontinuous barrier coating suitable for forming an inner layer of bag affixed to discrete areas of the continuous layer wherein the uncoated areas of the continuous layer are seal-forming areas for construction of the bag to form a seal in the bag. Such a film can be used for vertical form fill sealing processes for preparing a plurality of containers which are then separated from each other.

Such an arrangement has, however, a number of difficulties. Firstly, the film prepared in this way is expensive. Films which are not coated with discontinuous layers are significantly cheaper and available from a larger number of suppliers. Furthermore the use of a particular pattern for the discontinuous barrier coating layer means that the sheet can only be used for preparing containers of a particular size and shape which cannot be varied for any individual sheet. Additionally, while such an arrangement can be used for vertical form fill sealing, it is difficult to use the arrangement for other moulding techniques such as vacuum forming or thermoforming where the stretching of the sheet means that it is difficult to register the seal-forming areas in the forming machine with the uncoated areas of the film or where stretching of the film may cause the coating to thin excessively or crack or split open.

The present invention provides a process for producing a container containing a composition which comprises:

a. producing a pocket surrounded by a sealing portion in a film;

b. coating the inside of the pocket but not the sealing portion with a coating;

c. filling the pocket with the composition;

d. placing a film on top of the filled pocket and across the sealing portion; and

e. sealing the films together at the sealing portion.

Thus, in the present invention, a standard film can be used in the initial step wherein a pocket is formed. This film does not have to be provided with a discontinuous barrier coating. Instead the coating is provided after a pocket has been formed in the film. This ensures that the coating is in registration with the pocket, thus avoiding the possibility of coating being present on the areas which are sealed which can affect the strength of the seal.

The film may be a single film, or a laminated film as disclosed in GB-A-2,244,258. While a single film may have pinholes, the two or more layers in a laminate are unlikely to have pinholes which coincide. The film may be water insoluble or water-soluble (which term is taken to include water-dispersible).

The film may be produced by any process, for example by extrusion and blowing or by casting. The film may be unoriented, monoaxially oriented or biaxially oriented. If the layers in the film are oriented, they usually have the same orientation, although their planes of orientation may be different if desired.

The layers in a laminate may be the same or different. Thus they may each comprise the same polymer or a different polymer. If it is desired to have a water-soluble laminated film, each of the layers should be water-soluble.

Examples of water-insoluble polymers which may be used in a single layer film or in one or more layers of a laminate are poly(vinyl chloride), poly(ethylene terephthalate), polyethylene, polypropylene and polystyrene. Examples of water-soluble polymers which may be used in a single layer film or in one or more layers of a laminate are poly(vinyl alcohol) (PVOH) and cellulose derivatives such as hydroxypropyl methyl cellulose (HPMC). An example of a preferred PVOH is ethoxylated PVOH. The PVOH may be partially or fully alcoholised or hydrolysed. For example it may be from 40 to 100%, preferably from 70 to 92%, more preferably about 88%, alcoholised or hydrolysed. The degree of hydrolysis is known to influence the temperature at which the PVOH starts to dissolve in water.

The thickness of the film used to produce the pocket is preferably 40 to 300 μm, more preferably 80 to 200 μm, especially 100 to 160 μm, more especially 100 to 150 μm and most especially 120 to 150 μm.

The pocket may be formed by, for example, vacuum forming or thermoforming. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. One skilled in the art can choose an appropriate temperature, pressure or vacuum and dwell time to achieve an appropriate pocket. The amount of vacuum or pressure and the thermoforming temperature used depend on the thickness and porosity of the film and on the polymer or mixture of polymers being used. Thermoforming of PVOH films is known and described in, for example, WO 00/55045.

A suitable forming temperature for PVOH or ethoxylated PVOH is, for example, from 90 to 130° C., especially 90 to 120° C. A suitable forming pressure is, for example, 69 to 138 kPa (10 to 20 p.s.i.), especially 83 to 117 kPa (12 to 17 p.s.i.). A suitable forming vacuum is 0 to 4 kPa (0 to 40 mbar), especially 0 to 2 kPa (0 to 20 mbar). A suitable dwell time is, for example, 0.4 to 2.5 seconds, especially 2 to 2.5 seconds.

While desirably conditions chosen within the above ranges, it is possible to use one or more of these parameters outside the above ranges, although it may be necessary to compensate by changing the values of the other two parameters.

After the pocket has been produced, the inside of the pocket is coated with a coating.

The nature of the coating depends on its intended function. It may, for example, protect the film from the composition. Another possibility is that the coating may protect the composition from the atmosphere or from constituents of the film.

This coating step is carried out after the pocket has been formed, and is desirably carried out as soon as possible after the pocket has been formed. It may also be carried out at least partially during the step of forming the pocket. Some films are known to shrink away from the mould immediately after the pocket has been formed, particularly PVOH films. Accordingly, desirably steps are taken to ensure that shrinkage does not occur or is at least minimised. For example, a vacuum can be maintained to keep the film positioned securely in the mould. Alternatively substantially anhydrous PVOH can be used, for example having a water content of less than 5 wt %, which has less tendency to shrink away from the sides of the mould.

It is especially desirable in the present invention that the coating protects the film from the composition. Thus, for example, if the composition tends to dissolve a film forming the container, particularly if the composition contains more than 5 wt % free water (as determined by a standard loss-on-drying test) and the film is water-soluble, the coating can simply be a barrier layer which prevents the composition from contacting the water-soluble film.

The coating may, for example, be used to prevent or reduce reactions which occur within the film when contacting certain compositions. Thus it may, for example, prevent cross-linking and base hydrolysis reactions which can occur with PVOH homopolymer films. For example, compositions containing perborate ions may crosslink PVOH rendering it opaque and insoluble in water. Compositions which are strongly alkaline may cause base hydrolysis of the film, which also renders it insoluble in water.

Suitable coating compositions comprise PVOH. Suitable PVOHs are PVOH copolymers or ethoxylated PVOH which have good resistance to the enclosed compositions but which are often more expensive than the base PVOH film used to form the containers. Examples of PVOH copolymers which may be used are those in which at least some of the residual acetate groups on the PVOH are substituted by other groups, especially groups which are less susceptible to base hydrolysis or crosslinking reactions. Examples of such groups are alkyl groups, especially those containing from 1 to 4 carbon atoms such as methyl, ethyl and propyl groups. Such copolymers are commercially available. Suitable copolymers are, for example, Monosol (trade mark) M8630 and Aicello (trade mark) PT75.

Cellulose derivatives may also be used, such as HPMC or other film forming celluloses such as HPEC (hydroxy propyl ethyl cellulose), HEC (hydroxy ethyl cellulose) or SCMC (sodium carboxy methyl cellulose).

Other suitable film forming compositions comprise, for example, poly(vinyl dichloride), PTFE (polytetrafluoroethylene), gelatines, polyacrylates (for example those of the Carbopol (trade mark) series sold by BF Goodrich) or polyvinylpyrrollidones (for example Kollidon (trade mark) K30 or K90 sold by BASF).

The coating may also be used to protect the composition from the atmosphere or from constituents of the film. Thus, for example, the coating may be a gas barrier coating to protect the composition from atmospheric gases such as oxygen or carbon dioxide which may permeate through the film. This is especially advantageous when the composition is a foodstuff or deteriorates in the atmosphere. A suitable coating for this purpose is, for example, poly(ethyl vinyl alcohol) (EVOH). The coating may also protect the composition from constituents of the film which may have an undesirable influence on the composition, for example from plasticizers used in the film.

The coating is desirably applied to the film in the form of a solution which is subsequently dried. Suitably the solvent is water, although it can also be an organic solvent such as an alcohol, for example isopropyl alcohol, or acetone, or a hydrocarbon such as kerosene. Desirably the solvent is volatile in order to ensure a quick drying time, for example of the order of 1 to 5 seconds, especially 2.5 to 3 seconds. A suitable coating composition comprises the coating agent in an amount of, for example, 1 to 10 wt %, especially 3 to 7 wt %, more especially about 5 wt %.

The coating composition is desirably sprayed on the inside of the pocket. Suitable the composition is atomised although larger droplet sizes may also be used. The spraying head may be above the pocket, or may be placed inside the pocket in order to achieve a uniform coating thickness throughout the pocket. Suitable spraying machines are-high pressure airless spraying machines, such as the machines sold by Rexson. A suitable spray gun is, for example, the Rexson (trade mark) Type 1050 airless spray gun. Other suitable spray guns are the Pilot (trade mark) E88 airless spray gun, for example fitted with a 0.3 mm nozzle. However, systems with a remote nozzle on the end of a flexible pipe are preferred, such as a Titan Epic (trade mark) 440HP airless system fitted with a 0.178 mm (0.007 inch) nozzle.

The coating may also be formed by a printing method such as an ink-jet printing method. An example of such a method is given in U.S. Pat. No. 5,666,785. For example, an inkjet coder such as a Domino (trade mark) A300 printer fitted with a nozzle of appropriate size, for example a 40 μm nozzle, can be used, especially for lithium chloride sealing.

A further possibility is to use an electrostatic coating technique. Electrostatic coating techniques are known in the art and have been extensively used in the paint industry, for example in applying surface finishes in the white goods and automobile industries. Similar techniques may be used in the present invention. Alternatively the electrostatic spraying techniques in which liquid droplets are imparted with a unipolar charge by double layer charging of the liquid droplets during the spraying of the droplets, for example from an aerosol spray device, may be used. This technique is described in WO 97/28883 and WO 99/01227.

The coating is desirably dried before the pocket is filled. In a thermoforming process, since the film is still hot from the moulding step, drying is practically instantaneous. However, it is not necessary to dry the coating completely before the pocket is filled, especially when the composition is a liquid composition.

The thickness of the coating is desirably 10 to 50 μm, preferably 20 to 40 μm.

The pocket is then filled with the desired composition. The pocket may be completely filled or only partially filled. The composition may be a solid. For example, it may be a particulate or granulated solid, or a tablet. It may also be a liquid, which may be thickened or gelled if desired. The liquid composition may be non-aqueous or aqueous, for example comprising less than or more than 5% total or free water. The composition may have more than one phase. For example it may comprise an aqueous composition and a liquid composition which is immiscible with the aqueous composition. It may also comprise a liquid composition and a separate solid composition, for example in the form of a ball or pill.

The composition may be any composition which is intended to be released in an aqueous environment if the container is water-soluble. Thus, for example, it may be an agrochemical composition such as a plant protection agent, for instance a pesticide such as an insecticide, fungicide, herbicide, acaricide, or nematocide, a plant growth regulator or a plant nutrient. Such compositions are generally packaged in amounts of from 0.1 g to 7 kg, preferably 1 to 5 kg, when in solid form. When in liquid or gelled form, such compositions are generally packaged in amounts of from 1 ml to 10 litres, preferably 0.1 to 6 litres, especially from 0.5 to 1.5 litres.

The composition may also be a fabric care, surface care or dishwashing composition. Thus, for example, it may be a dishwashing, water-softening, laundry or detergent composition, or a rinse aid. Such compositions may be suitable for use in a domestic washing machine. The composition may also be a disinfectant, antibacterial or antiseptic composition, or a refill composition for a trigger-type spray. Such compositions are generally packaged in amounts of from 5 to 100 g, especially from 15 to 40 g. For example, a dishwashing composition may weigh from 15 to 20 g, a water-softening composition may weigh from 30 to 40 g.

The composition, if in liquid form, may be anhydrous or comprise water, for example at least 5 wt %, preferable at least 10 wt % water based on the weight of the aqueous composition. Desirably the composition contains less than 80 wt % water.

The remaining ingredients of the composition depend on the use of the composition. Thus, for example, the compositions may contain surface active agents such as an anionic, nonionic, cationic, amphoteric or zwitterionic surface active agents or mixtures thereof.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:

ROSO₃⁻M⁺

wherein R is a linear C₈-C₂₀ hydrocarbyl group and M is a water-solubilising cation. Preferably R is C₁₀-C₁₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:

CH₂(CH₂)ₓ(CHOSO₃⁻M⁺)(CH₂)ₘCH₃

wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:

CH₂(CH₂)ₓ(CHOSO₃⁻M⁺)CH₃ and

CH₃(CH₂)ₓ(CHOSO₃⁻M⁺) CH₂CH₃

for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:

RO(C₂H₄O)ₙSO₃⁻M⁺

wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium or potassium salts, and alkyl, for example C₈-C₁₈, benzene sulfonates.

Examples of nonionic surfactants are fatty acid alkoxylates, such as fatty acid ethoxylates, especially those of formula:

R(C₂HO)ₙOH

wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol nonionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated nonionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further nonionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type.

The total content of surfactants in the composition is desirably 60 to 95 wt %, especially 75 to 90 wt %. Desirably an anionic surfactant is present in an amount of 50 to 75 wt %, the nonionic surfactant is present in an amount of 5 to 20 wt %, and/or the cationic surfactant is present in an amount of from 0 to 20 wt %. The amounts are based on the total solids content of the composition, i.e. excluding any solvent which may be present.

The compositions, particularly when used as laundry washing or dishwashing compositions, may also comprise enzymes, such as protease, lipase, amylase, cellulase and peroxidase enzymes. Such enzymes are commercially available and sold, for example, under the registered trade marks Esperesc, Alcalasc and Savinasc by Nova Industries A/S and Maxatasc by International Biosynthetics, Inc. Desirably the enzymes are present in the composition in an amount of from 0.5 to 3 wt %, especially 1 to 2 wt %.

The compositions may, if desired, comprise a thickening agent or gelling agent. Suitable thickeners are polyacrylate polymers such as those sold under the trade mark CARBOPOL, or the trade mark ACUSOL by Rohm and Hass Company. Other suitable thickeners are xanthan gums. The thickener, if present, is generally present in an amount of from 0.2 to 4 wt %, especially 0.5 to 2 wt %.

Dishwasher compositions usually comprise a detergence builder. Suitable builders are alkali metal or ammonium phosphates, polyphosphates, phosphonates, polyphosphonates, carbonates, bicarbonates, borates, polyhydroxysulfonates, polyacetates, carboxylates such as citrates, and polycarboxylates. The builder is desirably present in an amount of up to 90 wt %, preferably 15 to 90 wt %, more preferable 15 to 75 wt %, relative to the total weight of the composition. Further details of suitable components are given in, for example, EP-A-694,059, EP-A-518,720 and WO 99/06522.

The compositions can also optionally comprise one or more additional ingredients. These include conventional detergent composition components such as further surfactants, bleaches, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners, and perfumes. If used, such optional ingredients will generally constitute no more than 10 wt %, for example from 1 to 6 wt %, the total weight of the compositions.

The builders counteract the effects of calcium, or other ion, water hardness encountered during laundering or bleaching use of the compositions herein. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan.

The builders generally constitute from 0 to 3 wt %, more preferably from 0.1 to 1 wt %, by weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt % of the compositions.

The compositions may optionally comprise materials which serve as phase stabilizers and/or co-solvents. Example are C₁-C₃ alcohols such as methanol, ethanol and propanol. C₁-C₃ alkanolamines such as mono-, di- and triethanolamines can also be used, by themselves or in combination with the alcohols. The phase stabilizers and/or co-solvents can, for example, constitute 0 to 1 wt %, preferably 0.1 to 0.5 wt %, of the composition.

The compositions may optionally comprise components which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are NaOH and citric acid.

After the pocket has been filled, a film is placed on top of the filled pocket and across the sealing portion, and the film are sealed together at the sealing portion. This film may be a single-layered film but is desirably laminated to reduce the possibility of pinholes allowing leakage through the film. The film may be the same or different as the film forming the pocket. Examples of suitable films are those given for the film forming the pocket.

If appropriate, steps should be taken to ensure that the covering film is protected from the composition held within the container, or has appropriate gas barrier properties or protects the composition from undesirable components in the film. For example, the film may be made of a polymer which does not adversely interact with the composition. Examples of such polymers are the polymers indicated above to be used as the coating, such as the PVOH copolymers or ethoxylated PVOH previously described. The film may also be previously coated with a suitable coating except on the sealing portion in the arrangement described in WO 00/64667. Another possibility is to coat the film in the appropriate areas just before it is used to cover the filled pocket, for example by using a similar spraying arrangement as used to spray the inside of the pocket in accordance with the process of the present invention.

Desirably the covering film has a thickness which is less than that of the film used for forming a pocket because it would not generally be stretched so localised thinning of the sheet will not occur. It is also desirable to have a thickness which is less than that of the film used to form a pocket to ensure a sufficient heat transfer through the film to soften the base web if heat sealing is used.

The thickness of the covering film is generally from 20 to 160 μm, preferably from 40 to 100 μm, such as 40 to 80 μm or 50 to 60 μm.

The films may be sealed together by any suitable means, for example by means of an adhesive or by heat sealing. Other methods of sealing include infra-red, radio frequency, ultrasonic, laser, solvent, vibration and spin welding. An adhesive such as an aqueous solution of PVOH may also be used. The seal desirably is water-soluble if the containers are water-soluble. The presence of a coating on the sealing portion of the film would hinder or prevent sealing and could cause a reduction in seal strength. Therefore, in the present invention, the sealing portion is left uncoated by the coating composition.

If heat sealing is used, a suitable sealing temperature is, for example, 120 to 195° C., for example 140 to 150° C. A suitable sealing pressure is, for example, from 250 to 600 kPa. Examples of sealing pressures are 276 to 552 kPa (40 to 80 p.s.i.), especially 345 to 483 kPa (50 to 70 p.s.i.) or 400 to 800 kPa (4 to 8 bar), especially 500 to 700 kPa (5 to 7 bar) depending on the heat sealing machine used. Suitable sealing dwell times are 0.4 to 2.5 seconds.

One skilled in the art can use an appropriate temperature, pressure and dwell time to achieve a seal of the desired integrity. While desirably conditions are chosen within the above ranges, it is possible to use one or more of these parameters outside the above ranges, although it would might be necessary to compensate by changing the values of the other two parameters.

If more than one container is formed at the same time from the same sheet, the containers may then be separated from each other by cutting the sealing portions, or flanges. Alternatively, they may be left conjoined and, for example, perforations provided between the individual containers so that they can be easily separated a a later stage, for example by a consumer. If the containers are separated, the flanges may be left in place. However, desirably the flanges are partially removed in order to provide an even more attractive appearance. Generally the flanges remaining should be as small as possible for aesthetic purposes while bearing in mind that some flange is required to ensure the two films remain adhered to each other. A flange having a width of 1 mm to 5 mm is desirable, preferably 1.5 mm to 2.5 mm, most preferably about 2 mm.

The containers may themselves be packaged in outer containers if desired, for example non-water soluble containers which are removed before the water-soluble containers are used.

The containers produced by the process of the present invention, especially when used for a fabric care, surface care or dishwashing composition, may have a maximum dimension of 5 cm, excluding any flanges. For example, a container may have a length of 1 to 5 cm, especially 3.5 to 4.5 cm, a width of 1.5 to 3.5 cm, especially 2 to 3 cm, and a height of 1 to 2 cm, especially 1.25 to 1.75 cm.

1. A process for producing a container containing a composition which comprises:
a. producing a pocket surrounded by a sealing portion in a film;
b. coating the inside of the pocket but not the sealing portion with a coating;
c. filling the pocket with the composition;
d. placing a film on top of the filled pocket and across the sealing portion; and
e. sealing the films together at the sealing portion.

2. A process according to claim 1 wherein the container is water-soluble.

3. A process according to claim 2 wherein both films comprise a poly(vinyl alcohol).

4. A process according to any one of the preceding claims wherein the pocket is formed by thermoforming the film.

5. A process according to any one of the preceding claims wherein the composition is a liquid composition.

6. A process according to claim 5 wherein the liquid composition comprises more than 5 wt % free water.

7. A process according to any one of the preceding claims wherein the coating protects the film from the composition.

8. A process according to any one of the preceding claims wherein the coating protects the composition from the atmosphere.

9. A process according to any one of the preceding claims wherein the coating comprises a poly (vinyl alcohol), a cellulose derivative, poly (vinyl dichloride), polytetrafluoroethylene, gelatine, polyacrylate or polyvinylpyrrollidone.

10. A process according to any one of the preceding claims wherein the coating is applied in the form of a coating solution and dried prior to filling the pocket with the composition.

11. A process according to claim 10 wherein the coating solution is applied by spraying or electrostatic deposition.

12. A process according to any one of the preceding claims wherein the composition is a fabric care, surface care or dishwashing composition.

13. A process according to claim 12 wherein the composition is a dishwashing, water-softening, laundry or detergent composition or a rinse aid.

14. A process according to claim 12 wherein the composition is a disinfectant, antibacterial or antiseptic composition or a refill composition for a trigger-type spray.

15. A process according to any one of claims 1 to 11 wherein the composition is an agricultural composition.
